(19) United States
(12) Patent Application Publication
(10) Pub. No.: US 2007/0206968 A1
(43) Pub. Date: Sep. 6, 2007

(54) Power supply and image fixing system using the same

(75) Inventor: Jong-moon Choi, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/588,310

(22) Filed: Oct. 27, 2006

(30) Foreign Application Priority Data
Mar. 3, 2006 (KR) 2006-0020388

(51) Int. Cl. G03G 15/00

(52) U.S. Cl. 399/88

(57) ABSTRACT

A power supply for use in an image fixing system is provided. The image fixing system includes first and second fixing lamps connected in series, a power supply unit supplying electric power, a power supply control unit controlling the supply of the electric power supplied from the power supply unit, a switching unit performing a switching operation according to a first effective voltage or a second effective voltage of the electric power and a dual voltage unit supplying the electric power to the first and second fixing lamps according to the switching result of the switching unit. Accordingly, by supplying a desired voltage to fixing lamps regardless of input electric power, it is not necessary to implement different types of fixing systems, thereby reducing manufacturing costs and time.

### CROSS-REFERENCE TO RELATED PATENT APPLICATIONS

This application claims the benefit under 35 U.S.C. §119(a) of Korean Patent Application No. 10-2006-0020388, filed on Mar. 3, 2006, in the Korean Intellectual Property Office, the entire disclosure of which is hereby incorporated by reference.

### BACKGROUND OF THE INVENTION

1. Field of the Invention

The present invention relates to a power supply. More particularly, the present invention relates to a power supply for applying a desired voltage in an image fixing system.

2. Description of the Related Art

The basic components of an image fixing system included in an image forming device are a power supply unit supplying electric power, a power supply control unit controlling the supply of the electric power, and a fixing lamp heating a fixing roller using the supplied electric power.

When the electric power is supplied by the power supply unit, the power supply control unit controls the supply of the electric power supplied to the fixing lamp according to a temperature of the fixing roller.

However, the electric power supplied by a conventional power supply unit could have an effective voltage of 110V or 220V. Thus, a first fixing system for an effective voltage of 110V and a second fixing system for an effective voltage of 220V must be provided. For example, if the power supply unit supplies 110V, a fixing lamp rated at 110V must be provided, and if the power supply unit supplies 220V, a fixing lamp rated at 220V must be provided.

Accordingly, there is a need for an improved power supply for use in an image fixing system to supply a desired voltage to a fixing unit regardless of the input voltage.

### SUMMARY OF THE INVENTION

Exemplary embodiments of the present invention address at least the above problems and/or disadvantages and provide the advantages described below. Accordingly, as aspect of the present invention is to provide a power supply for use in an image fixing system for supplying a desired voltage to a fixing unit regardless of input electric power.

According to an exemplary aspect of the present invention, there is provided an image fixing system comprising first and second fixing lamps connected in series, a power supply unit supplying electric power, a power supply control unit controlling the supply of the electric power supplied from the power supply unit, a switching unit performing a switching operation according to a first effective voltage or a second effective voltage of the electric power and a dual voltage unit supplying the electric power to the first and second fixing lamps according to the switching result of the switching unit.

### BRIEF DESCRIPTION OF THE DRAWINGS

The above and other features and advantages of certain embodiments of the present invention will become more apparent by describing in detail exemplary embodiments thereof with reference to the attached drawings in which:

FIG. 1 is a circuit diagram of an image fixing system according to an exemplary embodiment of the present invention;

FIGS. 2A and 2B are circuit diagrams of an exemplary embodiment where a first effective voltage is supplied by a power supply unit of FIG. 1; and

FIGS. 3A and 3B are circuit diagrams of an exemplary embodiment where a second effective voltage is supplied by the power supply unit of FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will now be described more fully with reference to the accompanying drawings.

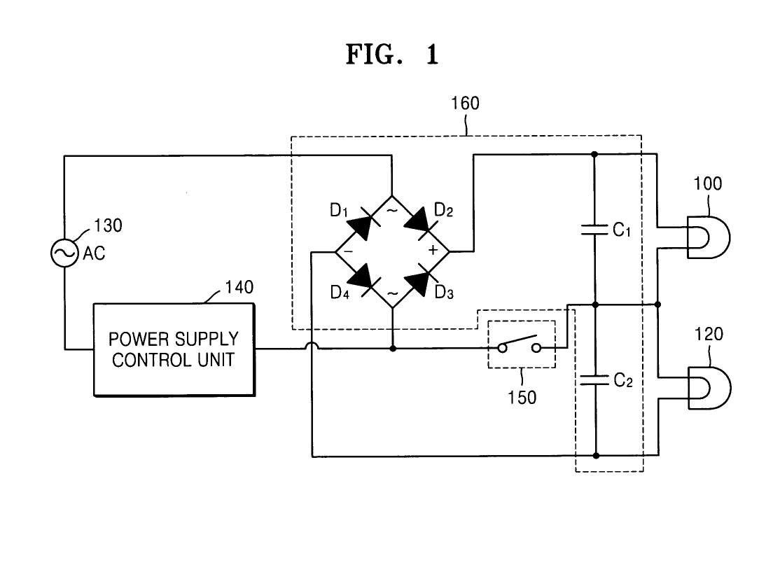

FIG. 1 is a circuit diagram of an image fixing system according to an exemplary embodiment of the present invention.

Referring to FIG. 1, a first fixing lamp 100 and a second fixing lamp 120 receive electric power and heat a fixing roller (not shown). In an exemplary embodiment, the first and second fixing lamps are halogen lamps. However, other types of lamps may be used. The first fixing lamp 100 and the second fixing lamp 120 are connected in series.

The first fixing lamp 100 and the second fixing lamp 120 are lamps rated for 110V power.

A power supply unit 130 supplies alternating current (AC) power to the first fixing lamp 100 and the second fixing lamp 120.

The power supply unit 130 can supply two effective voltages. That is, the power supply unit 130 can supply 220V power as a first effective voltage and 110V power as a second effective voltage.

A power supply control unit 140 controls the supply of the AC power supplied from the power supply unit 130 to the first fixing lamp 100 and the second fixing lamp 120. That is, if a temperature of the fixing roller exceeds a desired range, the power supply control unit 140 cuts off the AC power supplied from the power supply unit 130 to the first fixing lamp 100 and the second fixing lamp 120. If the temperature of the fixing roller is within the desired range, the power supply control unit 140 supplies the AC power supplied by the power supply unit 130 to the first fixing lamp 100 and the second fixing lamp 120.

In an exemplary embodiment, the power supply control unit 140 includes a photo triac as a switching element for on/off supply of the AC power. However, other switching elements may be used.

A switching unit 150 performs a switching operation according to the first or second effective voltage of the AC power. For example, if the AC power supplied by the power supply unit 130 is the first effective voltage, in other words 220V, the switching unit 150 performs an off switching operation. If the AC power supplied by the power supply unit 130 is the second effective voltage, in other words 110V, the switching unit 150 performs an on switching operation.

In an exemplary embodiment, a user can control the on/off switching operation of the switching unit 150. In another exemplary embodiment, the switching unit 150 can sense an effective voltage of the AC power supplied by the power supply unit 130 and automatically perform the on/off switching operation in response to the sensed effective voltage. To automatically perform the on/off switching operation according to a value of the effective voltage, the switching unit 150 can be implemented with an automatic voltage selection integrated circuit (IC).

A dual voltage unit 160 supplies the AC power to the first fixing lamp 100 and the second fixing lamp 120 according to the switching result of the switching unit 150.

If the AC power supplied by the power supply unit 130 is the first effective voltage, in other words 220V, the switching unit 150 is switched off, and thus the dual voltage unit 160 divides the 220v power into 110V power and supplies the 110V power to each of the first fixing lamp 100 and the second fixing lamp 120. If the AC power supplied by the power supply unit 130 is the second effective voltage, in other words 110V, the switching unit 150 is switched on, and thus the dual voltage unit 160 supplies voltage to each of the first fixing lamp 100 and the second fixing lamp 120 according to the flowing direction of a current of the AC power.

In an exemplary embodiment, the dual voltage unit 160 includes a bridge circuit. As illustrated in FIG. 1, the bridge circuit includes 4 diodes, in other words a first diode D₁, a second diode D₂, a third diode D₃, and a fourth diode D₄. The dual voltage unit 160 can further include a first capacitor C, connected in parallel to the first fixing lamp 100 and a second capacitor C₂ connected in parallel to the second fixing lamp 120 besides the bridge circuit.

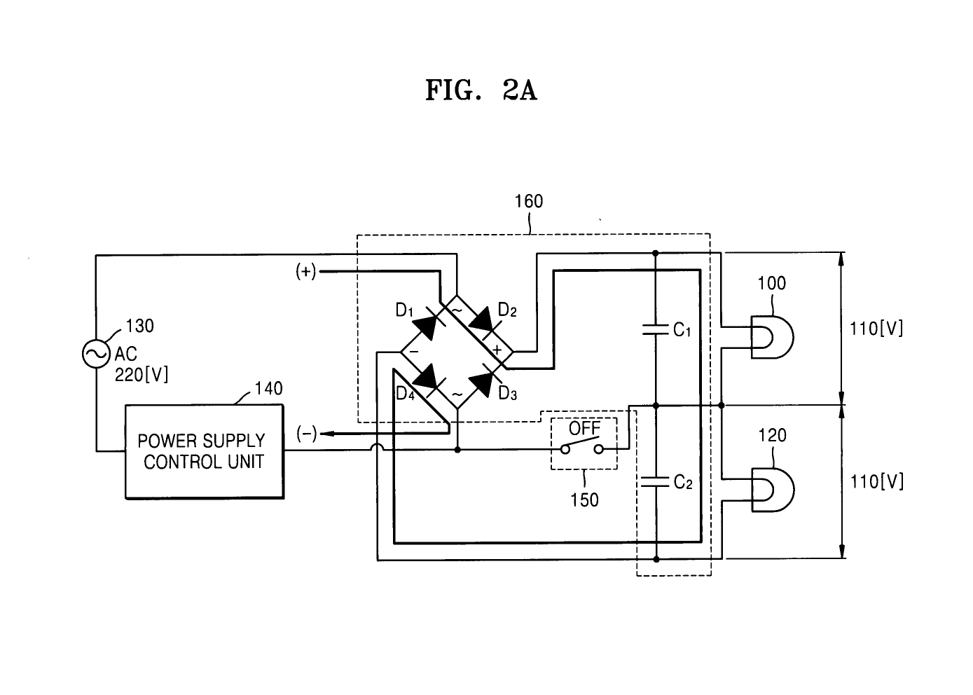

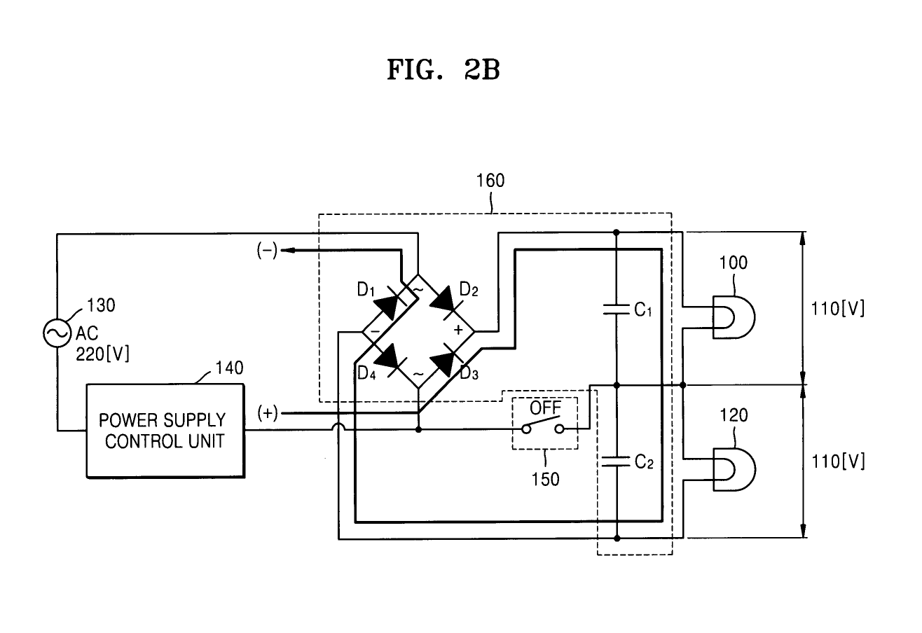

FIGS. 2A and 2B are circuit diagrams for a case where the first effective voltage, in other words 220V, is supplied by the power supply unit 130 of FIG. 1.

FIG. 2A shows an exemplary embodiment where the AC power flows in the positive direction. As illustrated in FIG. 2A, since the 220V power is supplied, the switching unit 150 is switched off. Thus, the 220V power sequentially flows along the second diode D₂, the first fixing lamp 100, the second fixing lamp 120, and the fourth diode D₄. Accordingly, the divided 110V power is applied to the first fixing lamp 100, and the remaining divided 110V power is applied to the second fixing lamp 120.

FIG. 2B shows a case when the AC power flows in the negative direction. As illustrated in FIG. 2B, since the 220V power is supplied, the switching unit 150 is switched off. Thus, the 220V power sequentially flows along the third diode D₃, the first fixing lamp 100, the second fixing lamp 120, and the first diode D₁. Accordingly, the divided 110V power is applied to the first fixing lamp 100, and the remaining divided 110V power is applied to the second fixing lamp 120.

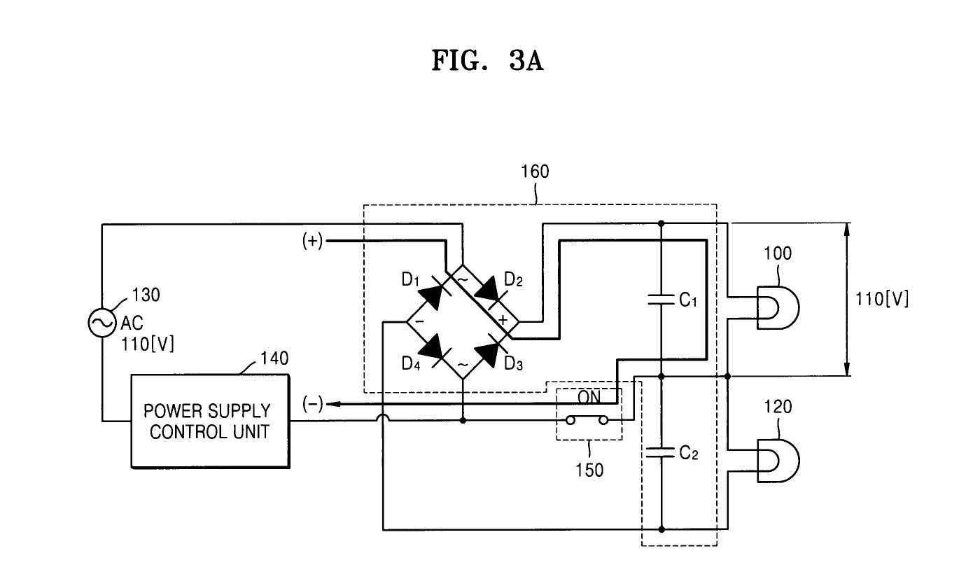

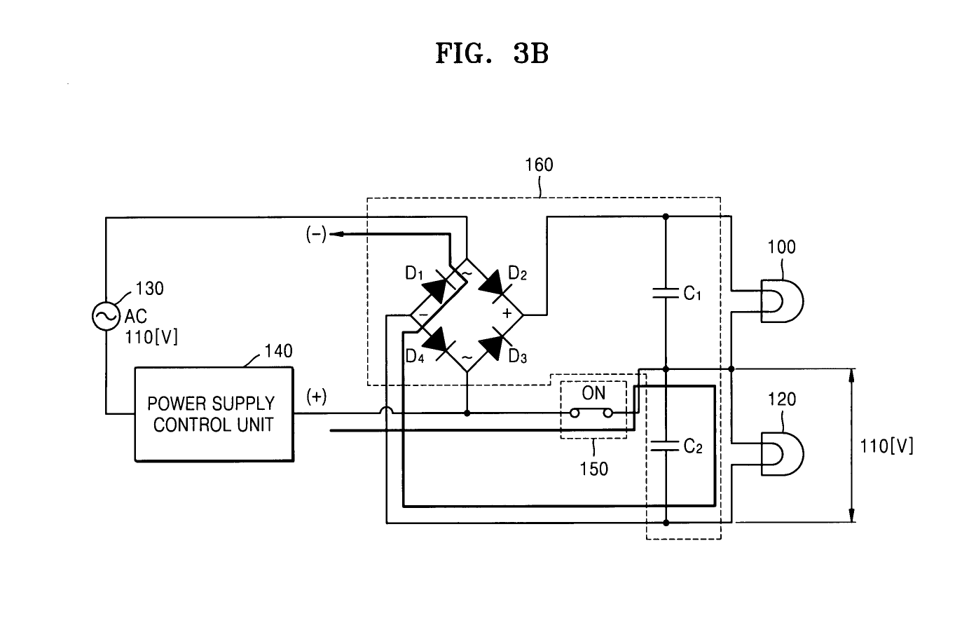

FIGS. 3A and 3B are circuit diagrams for a case where the second effective voltage, in other words 110V, is supplied by the power supply unit 130 of FIG. 1.

FIG. 3A shows a case when the AC power flows in the positive direction. As illustrated in FIG. 3A, since the 110V power is supplied, the switching unit 150 is switched on. Thus, the 110V power sequentially flows along the second diode D₂, the first fixing lamp 100, and the switching unit 150. Accordingly, the 110V power is applied only to the first fixing lamp 100, and no power is applied to the second fixing lamp 120.

FIG. 3B shows a case when the AC power flows in the negative direction. As illustrated in FIG. 3B, since the 110V power is supplied, the switching unit 150 is switched on. Thus, the 110V power sequentially flows along the switching unit 150, the second fixing lamp 120, and the first diode D₁. Accordingly, the 110V power is applied only to the second fixing lamp 120, and no power is applied to the first fixing lamp 100.

As described above, a desired voltage can be supplied to fixing lamps regardless of input electric power. Thus, it is not necessary to implement different types of fixing systems, thereby reducing manufacturing costs and time.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An image fixing system comprising:
first and second fixing lamps connected in series;
a power supply unit for supplying electric power;
a power supply control unit for controlling the supply of the electric power supplied from the power supply unit;
a switching unit for performing a switching operation according to a first effective voltage or a second effective voltage of the electric power; and
a dual voltage unit for supplying the electric power to the first and second fixing lamps according to a position of the switching unit.

2. The image fixing system of claim 1, wherein the power supply unit supplies 220V as the first effective voltage and 110V as the second effective voltage.

3. The image fixing system of claim 1, wherein the switching unit performs an off switching operation if the electric power supplied by the power supply unit is the first effective voltage and performs an on switching operation if the electric power supplied by the power supply unit is the second effective voltage.

4. The image fixing system of claim 1, wherein the switching unit performs an on/off switching operation in response to an operation of a user.

5. The image fixing system of claim 1, wherein the switching unit senses one of the first and second effective voltages of the electric power supplied by the power supply unit and performs an on/off switching operation in response to the sensed effective voltage.

6. The image fixing system of claim 1, wherein the dual voltage unit comprises a bridge circuit.

7. The image fixing system of claim 6, wherein the switching unit is provided between an input node of the bridge circuit and a node between the first and second fixing lamps.

8. The image fixing system of claim 1, wherein the dual voltage unit further comprises:
a first capacitor connected in parallel to the first fixing lamp; and
a second capacitor connected in parallel to the second fixing lamp.

9. A power supply apparatus, comprising:
a power unit for providing electric power;
a control unit for controlling the electric power provided from the power unit;
a switching unit for performing switching; and
a supply unit for supplying a first voltage and a second voltage according to a first and second position of the switching unit, respectively, wherein the first voltage and the second voltage are supplied to at least a first load and a second load.

10. The power supply apparatus of claim 9, wherein the first voltage is greater than the second voltage.

11. The power supply apparatus of claim 10, wherein the first voltage is substantially twice the second voltage.

12. The power supply apparatus of claim 9, wherein the switching unit is switched open if the first voltage is provided and is switched closed if the second voltage is provided.

13. The power supply apparatus of claim 12, wherein the switching unit is switched manually by a user.

14. The power supply apparatus of claim 12, wherein the switching unit switches automatically based on the voltage of the provided power.

15. The power supply apparatus of claim 9, wherein the supply unit comprises a bridge rectifying circuit.

16. The power supply apparatus of claim 15, wherein the switching unit is provided between an input node of the bridge rectifying circuit and a node between the first and second loads.

17. The power supply apparatus of claim 15, wherein the supply unit further comprises:
a first capacitor connected in parallel to the first load; and
a second capacitor connected in parallel to the second load.
